(19) United States
(12) Patent Application Publication
(10) Pub. No.: US 2004/0059648 A1
(43) Pub. Date: Mar. 25, 2004

(54) Duplicate thermal invoice slip

(76) Inventors: Kazutaka Nanbu, Kyoto-shi (JP); Takayasu Kumakawa, Kyoto-shi (JP); Kazuya Yamazaki, Kyoto-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/451,362

(22) PCT Filed: Dec. 25, 2001
(86) PCT No.: PCT/JP01/11369

(30) Foreign Application Priority Data
Dec. 28, 2000 (JP) 2000-403428

(51) Int. Cl. G06F 17/60

(52) U.S. Cl. 705/28

(57) ABSTRACT

A duplicate thermal slip 1 is a two-bound slip, and the first sheet is separated into two halves at a perforated line 2, the upper part being a docket 3, and the lower part being an invoice 5.

A heat sensitizing material 5a is applied to this invoice, and an arrival stub 6 is provided below the invoice. In other words, on the docket, a consignee code, a customer control number, date, an inquiry number, an arrival store code (4-15), consignee information, consignor information, a bar code and the like are printed. On the invoice 5, a consignee code, date, an inquiry number, consignee information, consignor information, a bar code and the like are printed. The same contents as those of the invoice 5 are duplicated on the arrival stub 6.

### DESCRIPTION

1. Technical Field

The present invention relates to a docket and an invoice used in the transportation industry such as a home delivery service.

2. Background Art

In general, the operation of a press bonding type slip is carried out in such a manner that, as shown in FIG. 6, a docket is printed by a customer terminal of a consignor, the slip is transmitted to a host computer in a home delivery agent (SCS), and a package with a docket adhered thereon is collected by a nearby branch.

The slip data is then transmitted from the home delivery agent to each branch. In the branch, which is the arrival store of the package, an invoice and an arrival stub are printed based on the distributed slip data. Then, the package, and the invoice and the arrival slip are printed.

Then the home delivery agent delivers the package with the invoice and the arrival stub to a consignee. The consignee puts the receiver's initial on the arrival stub, and receives the invoice and the package.

In the case of press bonding type, however, since the slip data is transmitted and output in the branch, transmission of the slip data may be delayed, and hence a truck cannot leave the branch to delay the delivery.

Therefore, when the output in the branch is not in time, a temporary slip is used to deliver the package to the consignee as soon as possible.

In the case of press bonding type, however, since the slip data is transmitted and output in the branch, if transmission of the slip data is delayed, a truck may not be able to leave the branch to delay the delivery. Moreover, when the output in the branch is not in time, a temporary slip can be used, but there is a problem in that the operation becomes complicated.

Furthermore, since the home delivery agent must prepare the invoice and the arrival stub, there is a problem in that it is time-consuming for the home delivery agent.

### DISCLOSURE OF THE INVENTION

In view of the above situation, it is an object of the present invention to provide a duplicate thermal invoice slip, which makes it possible that when there is a delivery request of a package from a customer, the home delivery agent can smoothly deliver the package to a consignee only with a slip prepared by the customer, without preparing the invoice and the arrival stub, thereby the system operation of the home delivery agent does not become complicated.

The duplicate thermal invoice slip of the present invention comprises: a first sheet of paper in which a docket of a predetermined shape, formed of a material including a nylon member, and an invoice of a predetermined shape, with a heat sensitizing material applied on the back, are connected with a perforated line therebetween; and a second sheet of paper of the same size as that of the invoice on the first sheet of paper, provided below the invoice, and compression bonded in the vicinity of the perforated line, so that characters are duplicated at the time of thermo press bonding to the invoice, wherein the first sheet of paper is at the uppermost position, the second sheet of paper is put below the invoice, and these are compression bonded on a paperboard in the vicinity of the perforated line and in a frame area of the docket.

A consignee code, a customer control number, delivery date, an inquiry number, an arrival store code, consignee information, consignor information, a bar code and the quantity are printed on the docket.

A consignee code, delivery date, an inquiry number, consignee information, consignor information, a bar code, the quantity, a freight number, an amount insured, and the designated delivery date are printed on the invoice.

The second sheet of paper is the arrival stub, and the arrival stub is provided with a column for a receiver's initial of the consignee.

The name of a home delivery agent, a mark of the home delivery agent and a thank you message are printed on the paperboard.

### BEST MODE FOR CARRYING OUT THE INVENTION

FIG. 1A is a diagram showing a duplicate thermal invoice slip according to the present invention. The duplicate thermal invoice slip 1 shown in FIG. 1A (hereinafter referred to as a duplicate thermal slip 1) is a two-bound slip. This duplicate thermal slip 1 is divided into two by separating the first sheet into halves at a dotted line (hereinafter referred to as a perforated line 2), and the upper half thereof is a docket 3. A consignee code, a customer control number, date, an inquiry number, an arrival store code (4-15), address of the consignee, address of the consignor, a bar code and the like are printed on the docket 3 by thermo press bonding. A paper in the area of the docket 3 is made of a material containing a nylon material, and the heat sensitizing material is not applied on the back thereof.

The lower half of the first sheet is an invoice 5, and a consignee code, an inquiry number, date, address of the consignee, address of the consignor, a bar code and the like are printed by thermo press bonding. This invoice is made of a thin thermal paper (carbon paper), and a heat sensitizing material 5a is applied on the back thereof.

A second sheet below the first sheet is an arrival slip 6 (see FIG. 1B), of the same size as that of the invoice 5 in the lower part of the first sheet, and is overlapped with the invoice on the first sheet and stuck together in the vicinity of the perforated line.

In such a duplicate thermal slip 1, the perforated line 2 and the peripheral frame of the docket 3 are compression bonded on a paperboard 7, so that characters printed on the invoice 5 are duplicated on the arrival stub on the second sheet. It is desired that the size of the duplicate thermal slip be about a size of a postcard.

In other words, as shown in FIG. 2, the invoice 5 in the lower part on the first sheet, and the arrival stub 6 on the second sheet below the invoice 5 can be turned over, centering on the perforated line 2 on the first sheet.

Moreover, as shown in FIG. 3B, on the surface of the paperboard, the name of the home delivery agent and a message from the home delivery agent are printed, and black lines are printed laterally on the upper side of the back.

Such a duplicate thermal slip 1 is printed and output in a system configuration as shown in FIG. 4.

In the system shown in FIG. 4, a customer terminal 8, a special purpose duplicate thermal printer 9 and a laser printer 10 are connected by the LAN, so that a customer opens a homepage by a browser function of a setup CD-ROM generated by the home delivery agent, using the customer terminal 1, to transfer the consignor information, the consignee information, the slip number and the like from the Internet server 2, by the selection of various software keys in the homepage, thereby the duplicate thermal slip 1, a package shipping and receiving document and the like can be obtained.

By the key selection in the homepage, the customer opens an invoice generation and input screen, an individually essential setup file information screen and the like, to create an invoice in a format desired by the customer (various slip creating function). For example, the duplicate thermal slip 1 is printed by the special purpose duplicate thermal printer 9, and package shipping and receiving document is printed by the laser printer 10.

In other words, an original slip of the duplicate thermal slip (original slip in which the first sheet and the second sheet are overlapped on the paperboard 7) is set in the duplicate thermal printer 9, and the duplicate thermal slip 1 is obtained by using the customer terminal in an interactive mode.

In the docket 3 on the upper part of the first sheet in the thermal slip 1, a consignee code, a customer control number, date, an inquiry number, an arrival store code (4-15), the address of the consignee, the address of the consignor, a bar code and the like are printed by thermo press bonding.

In the invoice 5 on the lower part thereof, a consignee code, an inquiry number, date, the address of the consignee, the address of the consignor, designated delivery date, a bar code and the like are printed by thermo press bonding. Since the heat sensitizing material is applied on the back 5a of the invoice 5, the characters printed on the invoice 5 are directly printed on the arrival stub 7 by thermo press bonding.

The package shipping and receiving document is in a form of a table, in which the receiver of the package delivered from the customer, order number, slip number and the like are written, and this can be obtained at the time of printing the duplicate thermal slip 1.

Therefore, as shown in FIG. 5, since two-bound duplicate thermal slip adhered on the paperboard 7 is obtained, the consignor keeps the package shipping and receiving document as a reserve, a driver adheres the duplicate thermal slip 1 on the package. The consignee will receive the invoice 5, and the driver brings back the arrival slip 6 on which the consignee has stamped with a seal. As a result, when there is a delivery request of a package from a customer, the home delivery agent can smoothly deliver the package to the consignee only with the slip prepared by the customer, without preparing the invoice and the arrival stub, and the system operation of the home delivery agent does not become complicated.

### INDUSTRIAL APPLICABILITY

The duplicate thermal invoice slip of the present invention has a configuration such that there are provided a first sheet of paper in which a docket of a predetermined shape, formed of a material including a nylon member, and an invoice of a predetermined shape, with a heat sensitizing material applied on the back, are connected with a perforated line therebetween, and a second sheet of paper provided below the invoice, and compression bonded in the vicinity of the perforated line, so that characters are duplicated thereon at the time of thermo press bonding to the invoice, wherein these sheets of paper are compression bonded on a paperboard in the vicinity of the perforated line and in a frame area of the docket. As a result, one slip provides the docket, the invoice and the arrival stub.

Therefore, the customer needs only to prepare the duplicate thermal invoice slip, and the home delivery agent need not prepare the invoice and the arrival stub. As a result, a package from the customer can be delivered to the consignee more quickly.

Moreover, a consignee code, delivery date, an inquiry number, consignee information, consignor information, a bar code, the quantity, a freight number, an amount insured, and the designated delivery date need only to be printed on the invoice, thereby the same contents are duplicated on the arrival stub located below. Therefore, the driver needs only to cut off this arrival stub, and ask the consignee to put the receiver's initial thereon.

Furthermore, since the frame and columns of the arrival stub are formed in a different color from those of the invoice and the docket, there is no possibility to give a wrong slip to the consignee by mistake.

### BRIEF DESCRIPTION OF DRAWINGS

FIG. 1A is a diagram showing a duplicate thermal slip in one embodiment.

FIG. 1B is a diagram showing an arrival stub on a second sheet.

FIG. 2 is a diagram showing a duplicate thermal slip in the embodiment.

FIGS. 3A, 3B are diagrams showing a paperboard in the duplicate thermal slip in the embodiment.

FIG. 4 is a system configuration diagram of a customer terminal for obtaining the duplicate thermal slip.

FIG. 5 is a diagram for explaining the operation of the duplicate thermal slip in the embodiment.

FIG. 6 is a diagram for explaining the operation of a conventional press bonding type slip.

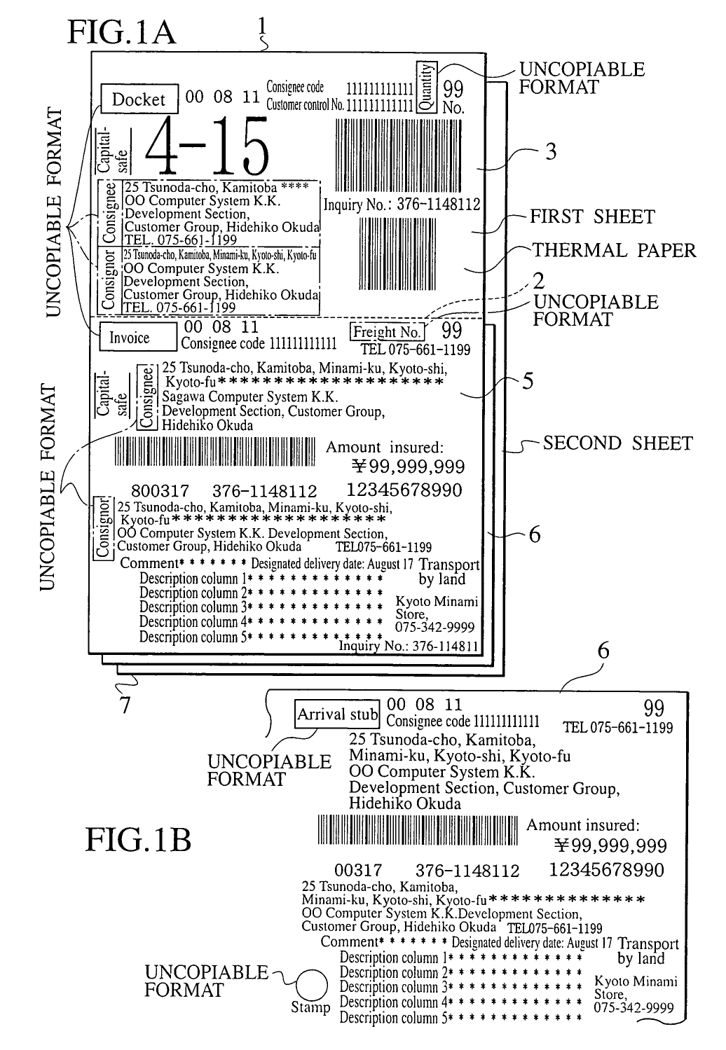

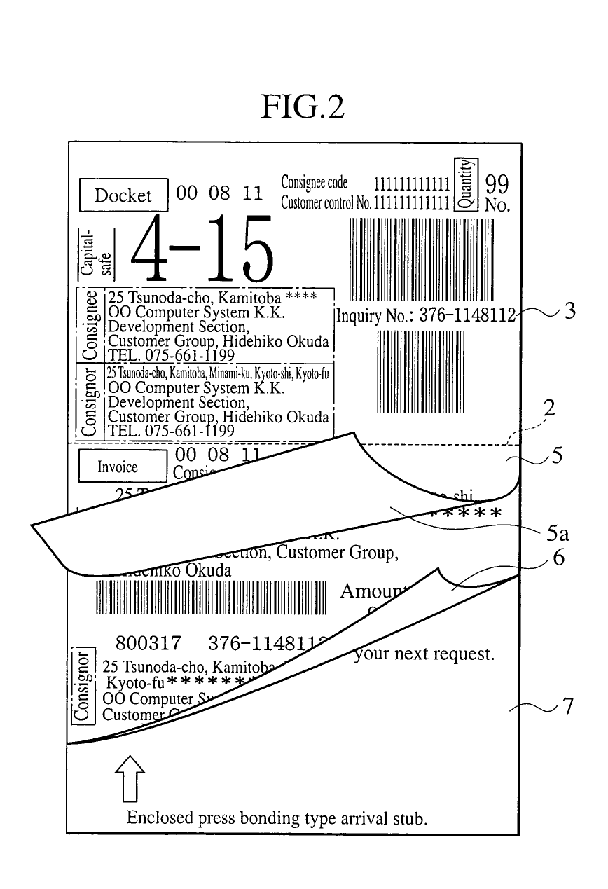

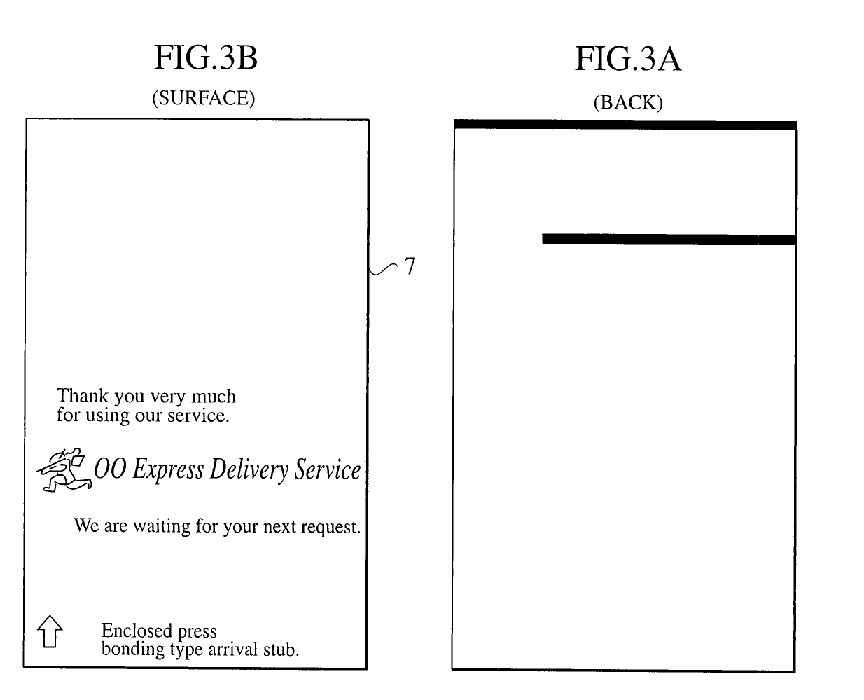

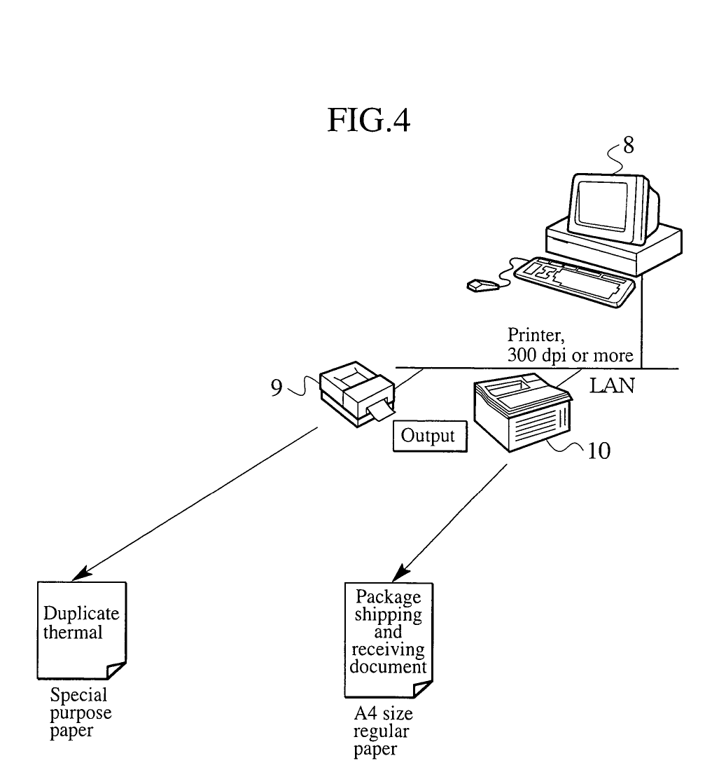

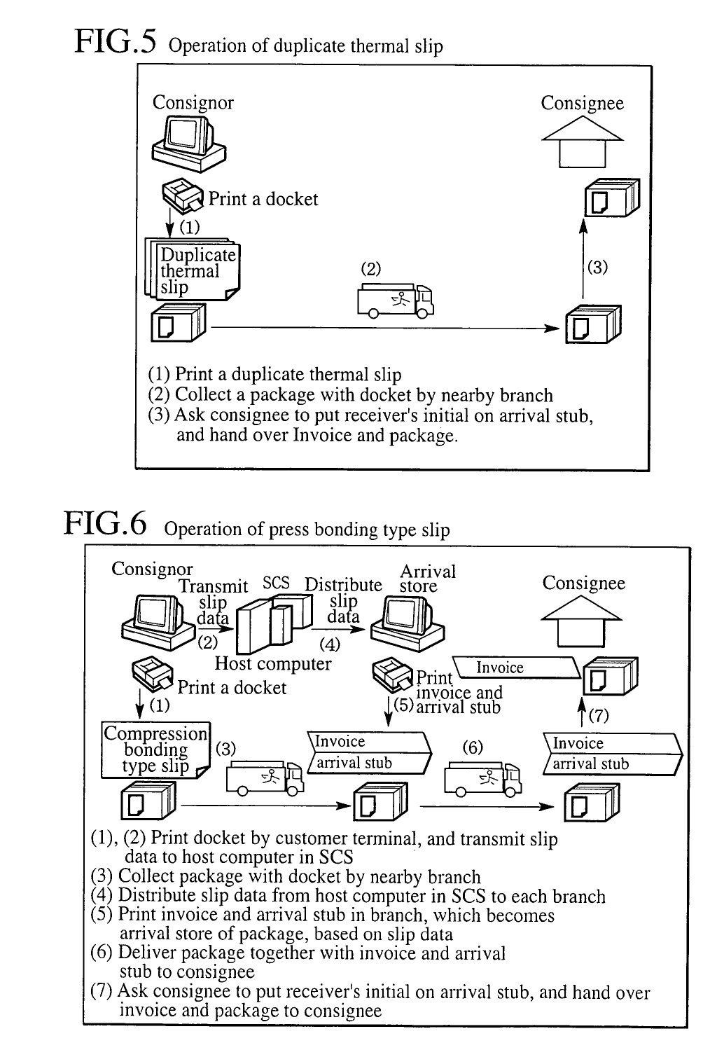

1. A duplicate thermal invoice slip comprising:
a first sheet of paper having a predetermined shaped docket formed of a material including a nylon member, and a predetermined shaped invoice, a heat sensitizing material applied on the back side of the invoice, the docket and the invoice are connected with a perforated line on the first sheet the paper; and
a second sheet of paper of the same size as that of the invoice on the first sheet of paper, provided below the invoice, and press bonded in the vicinity of the perforated line, so that characters are duplicated thereon at the time of thermo press bonding to the invoice, wherein
the first sheet of paper is at the uppermost position, the second sheet of paper is provided under the invoice, and the first sheet of paper and the second sheet of paper are press bonded on a paperboard in the vicinity of the perforated line and in a frame area of the docket.

2. A duplicate thermal invoice slip according to claim 1, wherein
a consignee code, a customer control number, delivery date, an inquiry number, an arrival store code, consignee information, consignor information, a bar code and the quantity are printed on the docket,
a consignee code, delivery date, an inquiry number, consignee information, consignor information, a bar code, the quantity, a freight number, an amount insured, and the designated delivery date are printed on the invoice,
the second sheet of paper is an arrival stub, and
the arrival stub comprising a column for a receiver's initial of the consignee.

3. A duplicate thermal invoice slip according to claim 1, wherein the name of a home delivery agent, a mark of the home delivery agent and an acknowledgment message are printed on the paperboard.

4. A duplicate thermal invoice slip according to any one of claims 1 to 3, wherein
in the docket of the first sheet of paper, a docket frame, a docket name, a column for consignee, a column for consignor, and a column for quantity are provided in advance in an untransferable form,
in the invoice, a frame for invoice, a column for consignee, a column for consignor, and a column for quantity are provided in advance in an untransferable form, and
on the second sheet of paper, a frame for the arrival stub, a column for consignee, a column for consignor, a column for quantity and a column for receiver's initial are provided in advance in an untransferable form.

5. A duplicate thermal invoice slip according to any one of claims 1 to 4, wherein the arrival stub name in the arrival stub is provided in the untransferable form, so as to be located immediately below the invoice name in the invoice.

6. A duplicate thermal invoice slip according to any one of claims 1 to 5, wherein the frame for the arrival stub, the column for consignee, the column for consignor, the column for quantity and the column for receiver's initial in the arrival stub are printed in a different color from those of the invoice and the docket in the first sheet of paper.
